(19) United States
(12) Patent Application Publication
(10) Pub. No.: US 2005/0087950 A1
(43) Pub. Date: Apr. 28, 2005

(54) Vehicle step

(76) Inventors: Alan Draper, LaVarne, CA (US); Peter Kekich, Palm Desert, CA (US)

Correspondence Address: STETINA BRUNDA GARRED & BRUCKER, 75 ENTERPRISE, SUITE 250, ALISO VIEJO, CA, 92656, US

(21) Appl. No.: 10/693,117

(22) Filed: Oct. 24, 2003

(51) Int. Cl. B60R 3/00

(52) U.S. Cl. 280/163

(57) ABSTRACT

A vehicle step, side step or running board is provided. One embodiment of the present invention employs a two-piece vehicle step comprising a first step member and a second step member that are structured to be fixedly attached quickly and easily by a consumer. A preferred embodiment of the present invention employs male and female elements that are secured together creating a vehicle step that can extend substantially between the front and rear axles of a full-sized or extended-bed pickup truck or sport-utility vehicle.

### FIELD OF THE INVENTION

The present invention generally relates to vehicle components. More particularly, the present invention relates to a vehicle side runner or vehicle step.

### BACKGROUND OF THE INVENTION

Trucks, sport utility vehicles, hybrid vehicles, and other similar vehicles are becoming increasingly popular with today's automotive consumer. One characteristic common to all these vehicles is a relatively high floorpan that requires the operator to “step-up” into the passenger compartment. Oftentimes, these vehicles are further modified with oversized wheels and tires, “raised” suspensions, and/or four-wheel drive systems. With these modifications, access to the passenger compartment becomes even more difficult.

Generally, vehicle owners will install a side runner, running board, or side-step along the side of the vehicle that provides an intermediate step to the passenger compartment. The designs of these side steps or running boards are as varied as the vehicles for which they are designed. The designs range from complex retractable running boards to simple short steps less than a foot in width.

Of course, the manufacturers of these step products charge the consumer for the shipping costs associated with delivery. In some instances, the longer vehicle steps, such as the axle-to-axle designs, cannot be shipped by non-commercial shippers, such as United Parcel Service (UPS) because of their length. In this case, the manufacturer must ship the vehicle step by using a commercial freight transporter that delivers the product to a distributor's warehouse. The customer must then go to the warehouse to obtain the product. Of course, this increases the cost of the product and increases the burden on the consumer, both of which negatively affect sales.

Therefore, there exists a need for a vehicle step, or running board that can be shipped easily and economically.

### SUMMARY OF THE INVENTION

In order to overcome the deficiencies with known, conventional vehicle side-steps or running boards, a two-piece vehicle step is provided. Briefly, the two-piece vehicle step allows a manufacturer to ship a step that would require the services of a commercial shipping company, if it were shipped in an assembled, or installed-length state.

More specifically, one embodiment of the present invention employs a two-piece vehicle step comprising a first step member and a second step member that are structured to be fixedly attached quickly and easily by a consumer. A preferred embodiment of the present invention employs male and female elements that are secured together creating a vehicle step that can extend substantially between the front and rear axles of a full-size or extended-bed pickup truck or sport-utility vehicle.

### BRIEF DESCRIPTION OF THE DRAWINGS

FIG. 1 is a perspective view of an installed vehicle step comprising one embodiment of the present invention;

FIG. 2 is a perspective view of the vehicle step of FIG. 1, shown assembled, prior to installation on a vehicle;

FIG. 3 is a perspective view of the mating area of the vehicle step illustrated in FIG. 2, showing elements of the vehicle step in phantom;

FIG. 4 is a perspective view of the mating area of the vehicle step illustrated in FIG. 2, just prior to assembly;

FIG. 5 is a perspective, partial cut-away view of the mating area of the vehicle step illustrated in FIG. 2; and

FIG. 6 is an enlarged view of a portion of the vehicle step illustrated in FIG. 5.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides a vehicle step that can be shipped, or transported without employing commercial shippers. This allows non-commercial shippers to be used, with the attendant reduction in cost, and increase in delivery locations and options.

TABLE 1

| Weight | | | | | | |
|---|---|---|---|---|---|---|
| (pounds) | | | | | UPS Supply | A Specter Air |
| & | | | | | Chain | & Ground |
| Maximum | | | | | Solutions | Freight |
| Length | Express | | Federal | | (commercial | (commercial |
| (inches) | Mail | DHL | Express | UPS | shipper) | shipper) |
| 150 | Weight | $66.89 | $63.19 | $63.24 | $168.54 | $150.00 |
| pounds, | cannot | | | | | |
| 115 inches | exceed 70 | | | | | |
| | pounds | | | | | |
| 50 pounds, | $23.78 | Not to | Not to | $20.23 | $168.54 | $150.00 |
| 130 inches | | exceed | exceed | | | |
| | | 120 | 120 | | | |
| | | Inches | inches | | | |
| 50 pounds, | Not to exceed | Not to | Not to | Not to | $168.54 | $150.00 |
| 150 inches | 130 Inches | exceed | exceed | exceed 130 | | |
| | | 120 | 120 | Inches | | |
| | | Inches | Inches | | | |

For example, as shown in TABLE 1, non-commercial shippers, such as United Parcel Service (UPS), Express Mail, DHL, and Federal Express, only ship objects that do not exceed 130 inches in length. DHL and Federal Express will not ship objects that exceed 120 inches in length. However, a vehicle step that is sized to fit an extended-cab pickup truck, or other large vehicle may be as long as 140 inches, or more (UPS is a registered trademark of United Parcel Service of America, Inc. of Atlanta, Ga.; Express Mail is a registered trademark of the United States Postal Service of Washington D.C.; DHL is a registered trademark of DHL Airways, Inc. of Redwood City, Calif.; and Federal Express is a registered trademark of Federal Express Corp. of Memphisrock, Tenn.).

There are several shortcomings associated with employing commercial shippers. First, as shown in TABLE 1, commercial shippers charge substantially more than non-commercial shippers, thus ultimately increasing product cost. Second, commercial shippers do not offer the number of delivery locations as non-commercial shippers. And third, many catalogs, such as JCWhitney, and others, will not carry items that must be shipped by commercial shipper (JCWhitney is a registered trademark of J C Whitney & Co. of Chicago, Ill.). This greatly reduces the channels through which manufacturers can offer their vehicle steps to the public. Subsequently, this reduces the number of consumers who may be exposed to the product, thereby negatively affecting sales.

One embodiment of the present invention employs a two-piece vehicle step comprising a first step member and a second step member that are structured to be fixedly attached quickly and easily by a consumer. A preferred embodiment of the present invention employs male and female elements that are secured together creating a vehicle step that can extend substantially between the front and rear axles of a full-size or extended-bed pick-up truck or sport-utility vehicle.

More specifically, one embodiment of the present invention employs a two-piece vehicle step comprising a first step member and a second step member that are structured to be fixedly attached to each other quickly and easily. A preferred embodiment of the present invention employs male and female elements that are secured together creating a vehicle step that can extend substantially between the front and rear axles of a full-size or extended-bed pickup truck or sport-utility vehicle.

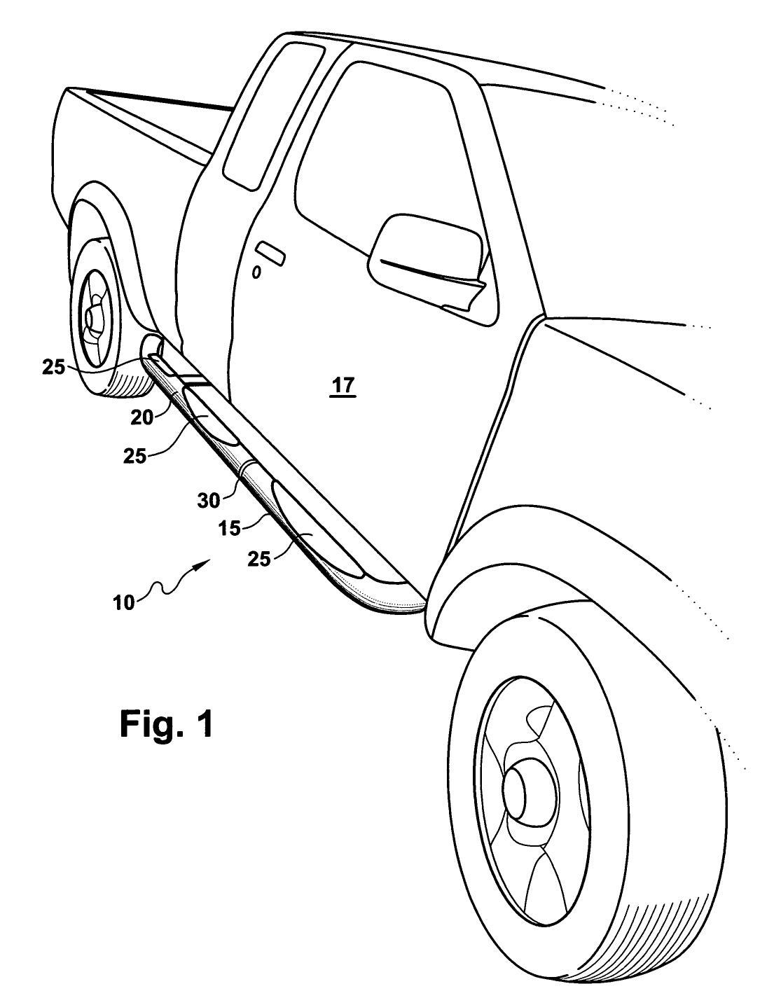

Referring to FIG. 1, a partitionable, or modular vehicle step 10 is illustrated. The step 10 comprises a first step element 15 and a second step element 20. Located on both step elements 15 and 20 are step areas 25. Alternatively, only one step element may have step areas 25. In a preferred embodiment, the first step element 15 and a second step element 20 are comprised of metal tubes. Specifically, one embodiment of the modular vehicle step 10 is constructed of a three inch (3.0) diameter metal tube, having a wall thickness of 0.065 inch. It will be appreciated that other tube dimensions and wall thicknesses may be employed, as well as circular tube equivalents, such as oval tubes, or other suitable shapes.

As shown in FIG. 1, a preferred embodiment vehicle step 10 is sized to fit substantially between the front and rear axles (not shown) of a vehicle 17, such as a pickup truck, sport utility vehicle, recreational vehicle, or other vehicle that may benefit from a step that aids operators and passengers entering the vehicle. It will be appreciated that a vehicle step, side step, or running board of any size will benefit from the partitionable, or modular concept that is one feature of the present invention. This is because the size of the step may be reduced, enabling the use of non-commercial shippers, with all the attendant advantages therein, as described above.

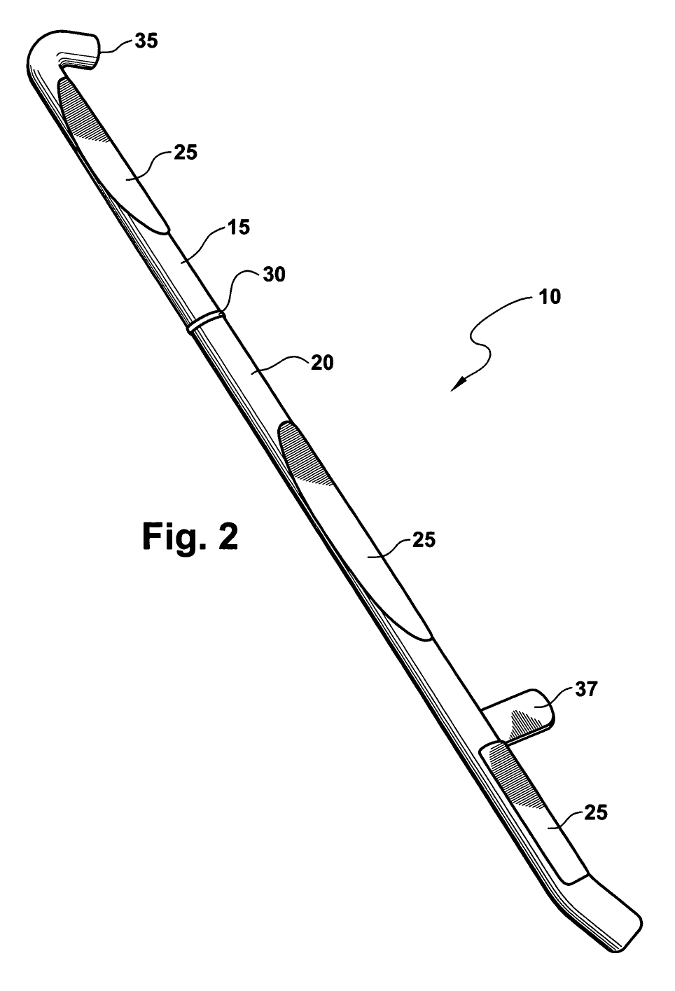

Referring to FIG. 2, the vehicle step 10 comprises a first end 35 located on the first step element 15. In the illustration, the first end 35 comprises an angular distal end of a tube comprising the first step element 15. It will be appreciated that alternative embodiments may not employ an angular distal end, or may employ ends having different shape configurations.

The first end 35 may be directly fastened to the vehicle 17, or a bracket, U-bolt, or other coupling device (not shown) may be used to attach the first end 35 to the vehicle 17. A frame coupling member 37 is located on the second step element 20. In the illustrated embodiment, the frame coupling member 37 is substantially perpendicular to the second step element 20, and comprises a metal tube of substantially the same dimensions as second step element 20.

Similar to the first end 35, the frame coupling member 37 may be directly attached to the vehicle 17, or it may be coupled to the vehicle 17 by brackets, U-bolts, fasteners, or any other suitable method or apparatus. It will be appreciated that alternative embodiment vehicle steps 10 may employ a frame coupling member 37 having a different angular relationship to the second step element 20.

Referring now to FIGS. 1 and 2, the step areas 25, that may be located on one, or both of, the first step element 15 and second step element 20. The step areas 25 are preferably comprised of a compressed, and thus recessed area of the step elements 15, 20. That is, an area of the metal tube comprising the first step element 15 and/or second step element 20 is partially crushed, or compressed, thereby creating a substantially flat area on the tube. It will be appreciated that the step area 25 may also be created by cutting out, or removing a portion of the metal tube.

Once the foundation for the step area 25 is formed, a material is then secured to the substantially flat, or recessed area, thereby creating the step area 25. The material may be any material that is durable, and that provides an anti-skid surface that is suitable for stepping onto. Preferably, the material is a plastic, polymer, metal, alloy, or equivalent. Specifically, any plastic, polymer, polyester, polyolefin, polycarbonate, polyamide, polyether, polyethylene, polytetrafluoroethylene, silicone, silicone rubber, rubber, polyurethane, DACRON, TEFLON, polyvinyl chloride, polystyrene, nylon, latex rubber, stainless steel, aluminum alloy, or metal alloy may be employed (DACRON and TEFLON are registered trademarks of E.I. du Pont de Nemours and Company of Wilmington, Del.).

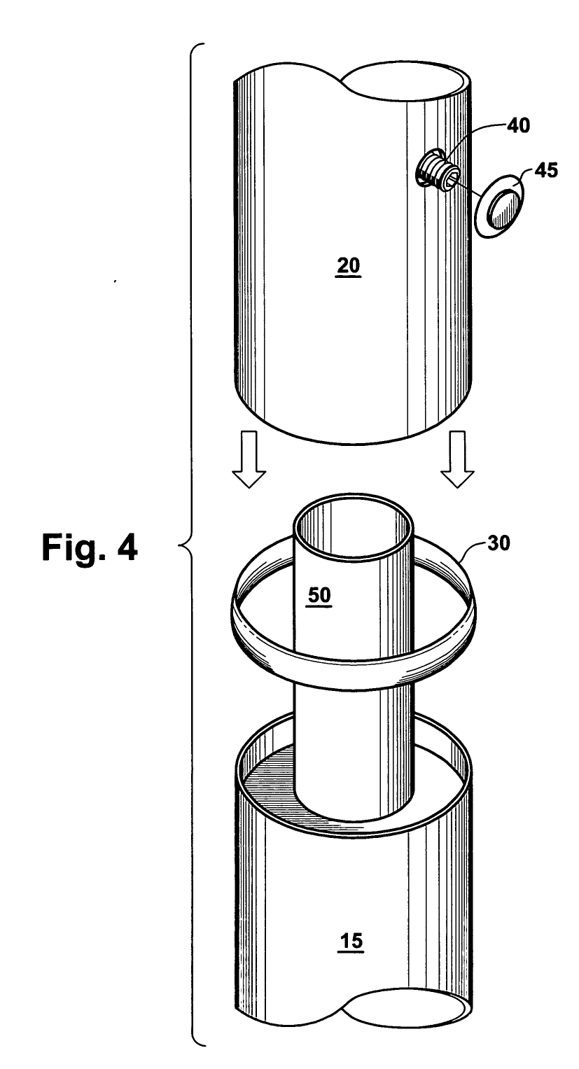

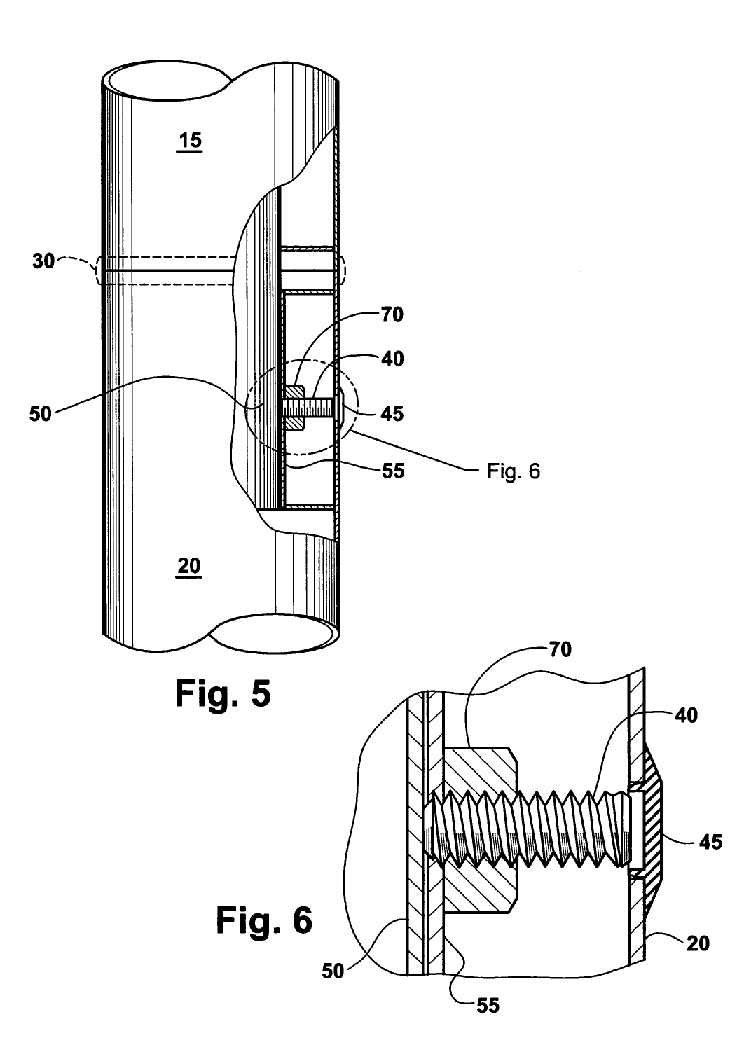

As shown in FIGS. 1-5, in a preferred embodiment of the present invention, a joint-cover, or band 30 covers the mating area where the first element 15 and second element 20 are coupled. The band 30 acts as a cosmetic cover for the mating area between the two elements 15, 20, and also seals the mating area, thereby preventing water or debris from entry through the mating area. Preferably, the band 30 is constructed of a plastic, or other suitable material, as listed above in connection with the step area(s) 25. Alternative joint-covers may be employed, such as two-piece designs that are attached to each step element 15, 20. In this embodiment, the two pieces would engage together when the two step elements 15, 20 are coupled. Alternatively, the joint-cover or band 30 may be eliminated.

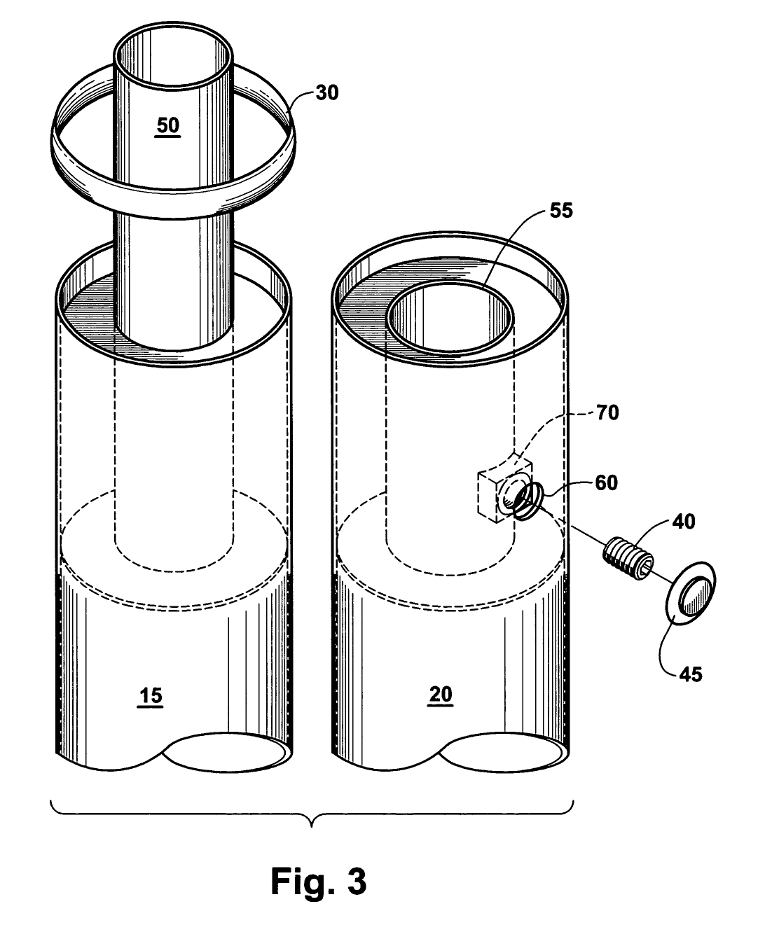

Referring now to FIGS. 3-5, a preferred embodiment mating system is illustrated. The mating system comprises a male element 50, attached to the first step element 15, and a female element 55, attached to the second step element 20. Of course, the location of male and female elements 50, 55 may be switched. In the illustrated embodiment, the male element 50 comprises a tube having a diameter of about 1.5 inches, and a length of about 4.5 inches. Alternative embodiments may be larger or smaller in diameter or length, and may comprise shapes other than a circular tube. The male element 50 is welded, or otherwise attached to the first step element 15.

Also shown in FIGS. 3-5 is the female element 55 that is sized to receive the male element 50. Preferably, the female element 55 comprises a tube having a diameter sized to receive the male element 50. In a preferred embodiment, the diameter of the female element 55 is about 1.5625 inches. Similar to the male element 50, the female element 55 is welded, or otherwise attached to the second step element 20.

One feature of the present invention is that a consumer may quickly and easily assemble the two step elements 15, 20, by inserting the male and female elements 50, 55, respectively, together. In this manner, a vehicle step 10 of a length suitable for extended-bed trucks, and other vehicles may be constructed.

Referring now to FIGS. 3-6, the second step element 20 also includes an anti-rattle system. In a preferred embodiment, the anti-rattle system comprises aperture 60, fastener 40, fastener receiver 70, and a cap, or cover 45. After the first and second step elements 15, 20, respectively, are coupled together, the fastener 40 is inserted into aperture 60. Positioned beneath the aperture 60 is the fastener receiver 70. The fastener receiver 70 preferably comprises a threaded element, such as a nut, sleeve, or other suitable device.

As shown in FIGS. 3, 5 and 6, the fastener receiver 70 is mounted to the female element 55, which has an aperture through which the fastener 40 can pass, as shown in FIG. 6. Thus, as the fastener 40 is inserted into the aperture 60, and into fastener receiver 70, it passes through the female element 55, and engages the male element 50. The fastener 40 biases, or otherwise fixes the male element 50 within the female element 55, as shown in FIG. 6. In this fashion, any relative movement between the male and female elements 50, 55, respectively, is eliminated, thereby eliminating any rattling, or other noise.

It will be appreciated that alternative anti-rattle systems may be employed. For example, the male or female elements, 50, 55 respectively, may include grommets, O-rings, or other suitable devices that would substantially eliminate any relative movement, and subsequent rattle between the two elements.

In the preferred embodiment illustrated in FIGS. 3-6, a cap, or cover 45 is positioned over the aperture 60. The cap 45 provides a cosmetic cover over the aperture 60, as well as eliminating the intrusion of water or debris into the aperture 60. Preferably, the cap 45 is constructed of a plastic, or other suitable material, as listed above in connection with the step area(s) 25.

Thus, it is seen that a vehicle step is provided. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. Many designs other than the above-described embodiments will fall within the literal and/or legal scope of the following claims, and the present invention is limited only by the claims that follow. It is noted that various equivalents for the particular embodiments discussed in this description may practice the invention as well.

1. A vehicle step, comprising:
a first elongate member including a first coupling section and having a male element comprising a tube disposed in radially spaced relation to the first elongate member and being attached to the first elongate member; and
a second elongate member including a second coupling section and having a female element comprising a tube disposed in radially spaced relation to the second elongate member and being attached to the second elongate member;
wherein the male element is insertable within the female element.

2. (canceled)

3. The vehicle step of claim 1, wherein the first and second elongate members are substantially tubular and structured to couple to a vehicle.

4. The vehicle step of claim 1, wherein the first elongate member includes a first end and a second end, wherein the first end is structured to couple to a vehicle and the second end includes a male element.

5. The vehicle step of claim 1, wherein the second elongate member includes a first end, a second end and a frame coupling member, wherein the first end comprises a female element, and the frame coupling member is structured to couple to a vehicle.

6. The vehicle step of claim 1, further comprising an anti-rattle member.

7. A vehicle step, comprising:
a first elongate member including a first coupling section;
a second elongate member including a second coupling section; and
a fastener positioned in the second coupling section, the fastener arranged to extend through the second coupling section so that it contacts the first coupling section.

8. The vehicle step f claim 1, further comprising a band sized to conceal a portion of the vehicle step.

9. The vehicle step of claim 1, further comprising a step surface located on the first member, or the second member, or on both members.

10. A vehicle step comprising:
a first member having a first end comprising a male element disposed in radially spaced relation to the first member;
a second member having a second end comprising a female element disposed in radially spaced relation to the second member; and
wherein the first member and second member are fixedly attached by positioning the male element within the female element.

11. The vehicle step of claim 10, wherein the male element comprises an elongate tube and the female element comprises an aperture within the second member.

12. The vehicle step of claim 10, wherein the first member and second member are fixedly coupled to a vehicle.

13. The vehicle step of claim 10, further comprising a step surface located on the first member, or the second member, or on both members.

14. A method of assembling a vehicle step as claimed in claim 1, the method comprising the steps of:
providing the first and second elongate members; and
inserting the male element of the first member into the female element of the second member.

15. The vehicle step of claim 14, wherein the portion of the first member comprises an elongate tube and the portion of the second member comprises an aperture sized to receive the elongate tube.

16. The vehicle step of claim 14, wherein the at least two members are fixedly coupled to a vehicle.

17. The vehicle step of claim 14, further comprising a step surface located on the at least two members.

18. (canceled)

19. (canceled)

20. (canceled)

21. The vehicle step of claim 1 wherein the male element is welded to the first elongate member and the female element is welded to the second elongate member.

22. The vehicle step of claim 1 wherein the male and female elements each comprises a tube, the male element being of a smaller diameter than that of the female element.

23. A vehicle step, comprising:
a fastener;
a fastener receiver;
a tubular first elongate member having a step surface located thereon and having a male element comprising a tube disposed in radially spaced relation to the first elongate member, the tube being welded to the first elongate member and having the fastener receiver mounted thereon; and
a tubular second elongate member having a step surface located thereon and having a female element comprising a tube disposed in radially spaced relation to the second elongate member, the tube being welded to the second elongate member, the second elongate member including an aperture formed therethrough and being disposed radially in general alignment with the fastener receiver;
wherein the male element is of a smaller diameter than that of the female element such that the male element is insertable within the female element, the fastener being insertable through the aperture, engageable with the fastener receiver and extended through the male element into direct engagement with the female element to prevent relative movement therebetween to couple the first elongate member to the second elongate member, the first and second elongate members each being configured to couple to a vehicle.

24. The vehicle step of claim 23 further comprising a cap sized and configured to be complementary to the aperture and engageable thereto.

25. The vehicle step of claim 23 further comprising a band sized and configured to conceal a portion of a mating area located between the first and second elongate members.
